(19) United States
(12) Patent Application Publication
(10) Pub. No.: US 2003/0227437 A1
(43) Pub. Date: Dec. 11, 2003

(54) Computer pointing device and utilization system

(76) Inventor: Nohl W. Ramirez, Kent, WA (US)

Correspondence Address: Delbert J. Barnard, BARNARD & PAULY, P.S., P.O. Box 58888, Seattle, WA, 98138-1888, US

(21) Appl. No.: 10/163,776

(22) Filed: Jun. 5, 2002

(51) Int. Cl. G09G 5/00

(52) U.S. Cl. 345/156

(57) ABSTRACT

An optical sensor (46) and two “click” buttons (50, 52) are mounted on a band (54) that is mountable onto the thumb of a computer user's hand. The “click” buttons (50, 52) are mounted side-by-side across the thumb. The optical sensor (46) is positioned endwise outwardly along the thumb (42) from the “click” buttons (50, 52). The band (54) is mounted on to a computer user's thumb (42) outwardly of the thumb joint. The optical sensor (46) and the “click” buttons (50, 52) confront the index and middle fingers (66, 68) on the user's hand. A relative movement of one of the user's fingers (66, 68) across the optical sensor generates a signal that controls movement of the cursor or pointer on a video display. Activation of the “click” buttons control specific software and pointing device functions.

### RELATED APPLICATIONS

This application claims priority based on provisional application Serial No. 60/295,757, filed Jun. 4, 2001, and entitled Ergonomic Computer Pointing Device.

### TECHNICAL FIELD

This invention relates to computer pointing devices and utilization systems. More particularly, it relates to a pointing device that is positionable on a users hand, and is usable to execute program functions and control pointer and cursor movement in the X-Y plane of a computer video display, while allowing a users hand and body to be in a relaxed position and while allowing unimpeded use of a keyboard.

### BACKGROUND OF THE INVENTION

There are several types of computer input devices, the most common types being the “mouse” and “trackball.” The most common “mouse” is a surface based input device. It must be used on a surface to function because it includes a tracking mechanism in contact with the surface that rotates when the mouse is moved over the surface. A disadvantage of this type of device is that it limits the positions that the users hand can be in since the mouse is grasped with the hand on its top. The user's body position is also limited by the need for a base surface and the user must make repeated motions to and from the keyboard. There is a known “mouse” that uses an optical sensor in place of a rolling ball sensor. It provides less limitation to body position since it can be used on the users leg but it does not solve the problems of limited hand position and repeated motion to and from the keyboard.

The “trackball” provides the same problems as a mouse. The “trackball” is a surface based pointing device with a rotating ball on top while the hand is placed atop the ball. The same attributes are associated with this device, limited hand position, limited body position and repeated motion to and from the keyboard.

Another type of pointing device is a hand worn pointing device or glove. Devices of this kind were developed in an attempt to alleviate the problems associated with the mouse and trackball. One such device is disclosed by U.S. Pat. No. 6,097,369, granted Aug. 1, 2000, to Mark L. Wambach. This device requires that a glove be worn, covering the entire hand. A disadvantage of this device is it is much larger than needed to produce the desired result of pointer movement on a computer screen. Also, the buttons and controls are awkwardly placed and overly complicated to use. Hands are different sizes and the glove may not fit properly rendering usability awkward and difficult. Another such device is disclosed by U.S. Pat. No. 6,154,199, granted Nov. 28, 2000, to Craig L. Butler. The device of this patent has similar features and functions as the device of U.S. Pat. No. 6,097,369.

There is a need for a hand worn pointing device that allows the user to rest his hand in the most comfortable position while using the device and operating the computer. There is a further need for a hand worn pointing device that is not restricted to use on a surface and which eliminates repeated motion from a surface base pointing device to a keyboard. There is also a need for a hand-held pointing device that can be adjusted to fit each user's hand size and which can be mounted to either the right or the left hand. The primary object of the present invention is to provide a hand-held pointing device which fulfills these needs.

### BRIEF SUMMARY OF THE INVENTION

The input device of the present invention is basically characterized by a band that is mountable on a computer user's thumb. This band supports a sensor that is directed towards the fingers of the hand that are adjacent the thumb. The sensor is a part of a cursor control circuit that is adapted to control x-y positioning of a cursor on a computer screen in response to finger movement relative to the sensor.

Another object of the present invention is to provide a thumb band support for both a sensor and one or more “click” buttons. In preferred form, the band supports of pair of “click” buttons.

A further object of the invention is to provide two “click” buttons on the band, positioned side-by-side across the thumb, and a sensor positioned on the band outwardly along the thumb from the “click” buttons.

A still further object of the invention is to provide a band that is positionable on a computer user's thumb outwardly of the thumb knuckle. This band supports a sensor and preferably supports at least one “click” button in close proximity to the sensor.

Yet another object of the invention is to provide an input device that includes a control circuit housing that is positionable on the back of the computer user's hand. As many electrical conductors as are necessary extend from the sensor along the computer user's thumb and hand to circuitry within the housing.

Another object of the invention is to provide a second band that is mountable on the computer user's thumb inwardly of the thumb knuckle. The necessary conductors extend from the sensor and “click” buttons supported by the first band to the second band and from the second band to the circuitry within the housing at the back of the hand.

The pointing device of the invention allows the user to rest his/her hand in the most comfortable position and allows any body positions since it is not restricted to use on a surface and it eliminates repeated motion from a surface base of pointing device to a keyboard. The pointing device of the invention uses area on the thumb and a portion of the back of the hand and can be adjusted to fit the user's hand size. One pointing device can be used for both left and right hands. The mechanism used to detect and move the position of the pointer, and the “click” buttons used for functions, are placed on the forward part of the thumb and are manipulated by use of the adjacent fingers. Signal transmission can be by way of a connector cord. Preferably, however, wireless transmission is used. A radio transmitter is preferred and it is adapted to rely the electrical signal from the pointing device to the computer control. The pointing device of the invention provides unlimited hand and body positions and it can be used in conjunction with a keyboard.

Other objects, advantages and features of the invention will become apparent from the description of the best mode set forth below, from the drawings, from the claims and from the principles that are embodied in the specific structures that are illustrated and described.

### BRIEF DESCRIPTION OF THE SEVERAL VIEWS OF THE DRAWING

Like reference numerals are used to designate like parts throughout the several views of the drawing, and:

FIG. 1 is a schematic view of the prior art system that is disclosed by U.S. Pat. No. 6,145,199;

FIG. 2 is a view of a hand worn pointing device that embodies the present invention, such view showing the device as it appears when looking towards the palm side of the user's hand;

FIG. 3 is a schematic view of a system of the present invention, showing the pointing device on the right hand of the user and showing the right hand of the user positioned on a keyboard;

FIG. 4 is a view of the pointing device of the present invention as it appears when looking towards the side of the thumb of the user's hand which confronts the index finger on the user's right hand;

FIG. 5 is a pictorial view of a preferred embodiment of the invention, such views including arrows showing where some movement can occur and further showing the circuit housing partially fragmented to expose circuit components inside of the housing;

FIG. 6 is a side view of the embodiment shown by FIG. 5, such view also including arrows indicating where movement can occur;

FIG. 7 is a side elevational view of the sensor housing, including a phantom line showing some internal components;

FIG. 8 is a top plan view of the sensor housing, taken substantially along line 8--8 of FIG. 7, such view including phantom line showings of other components;

FIG. 9 is an end view of the sensor housing shown by FIGS. 7 and 8, such view being taken substantially along line 9--9 in FIG. 8;

FIG. 10 is a pictorial view of a frame assembly that extends between the thumb assembly and the circuit housing;

FIG. 11 is an exploded pictorial view of the frame assembly shown by FIG. 10;

FIG. 12 is a cross sectional view of the frame assembly shown by FIGS. 10 and 11;

FIG. 13 is an exploded sectional view of the frame assembly shown by FIGS. 10-12; and

FIG. 14 is a pictorial view showing the preferred embodiment of the invention mounted onto the right hand of a user, with the sensor and “click” buttons directed towards the fingers of the hand that are adjacent the thumb.

### DETAILED DESCRIPTION OF THE INVENTION

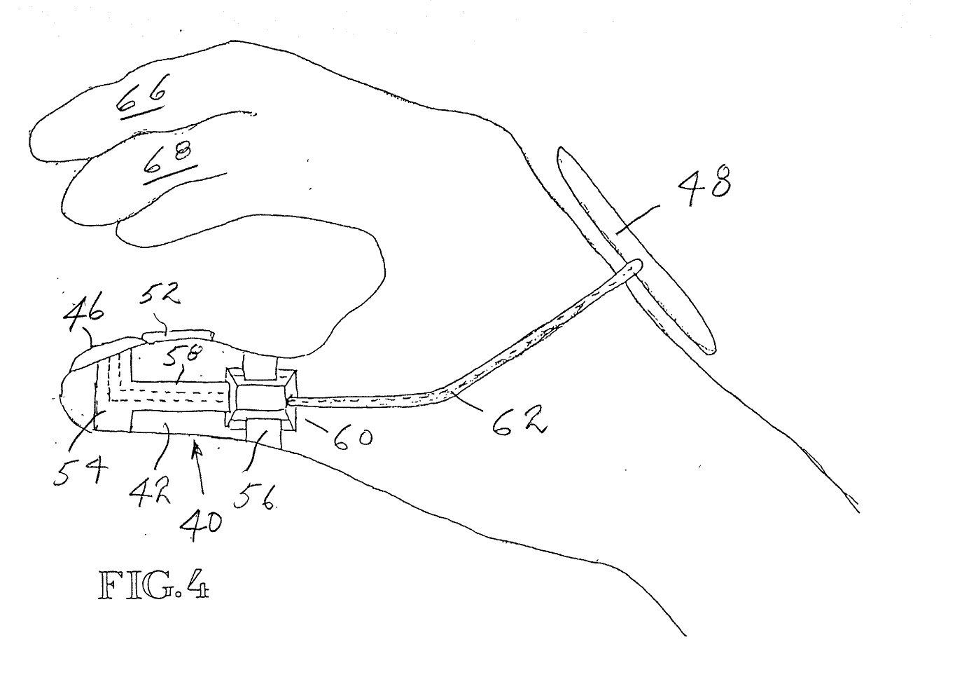

FIG. 1 is like FIG. 4 in U.S. Pat. No. 6,154,199. It discloses a hand mounted mouse 10 which includes a glove 12 and a tracking ball 16. The tracking ball 16 is positioned where it can be operated by the user's thumb. The glove includes a device 18 that is adapted to generate an electrical signal in response to rotational movement of the tracking ball 16. “Click” buttons are mounted on the palm side of the glove 12. The backside of the glove 12 includes the circuitry contained in a housing 30. The tracking ball device 16, 18 and the “click” buttons are connected to the circuitry contained in a housing 30. The circuitry contained in housing 30 transmits signals, e.g. radio waves, to a receiver 32 that is connected to control functions of a computer 26.

Existing pointing device technology includes a cordless mouse in which the tracking ball has been replaced by an optical sensor. One such device is produced by “Logitech, Inc.,” having a place of business at 6505 Kaiser Drive, Fremont, Calif. Currently, this device is marketed under the trademark “MouseMan.” The pointing device of the present invention utilizes this optical-cordless technology and at the same time provides significant improvements in ergonomics.

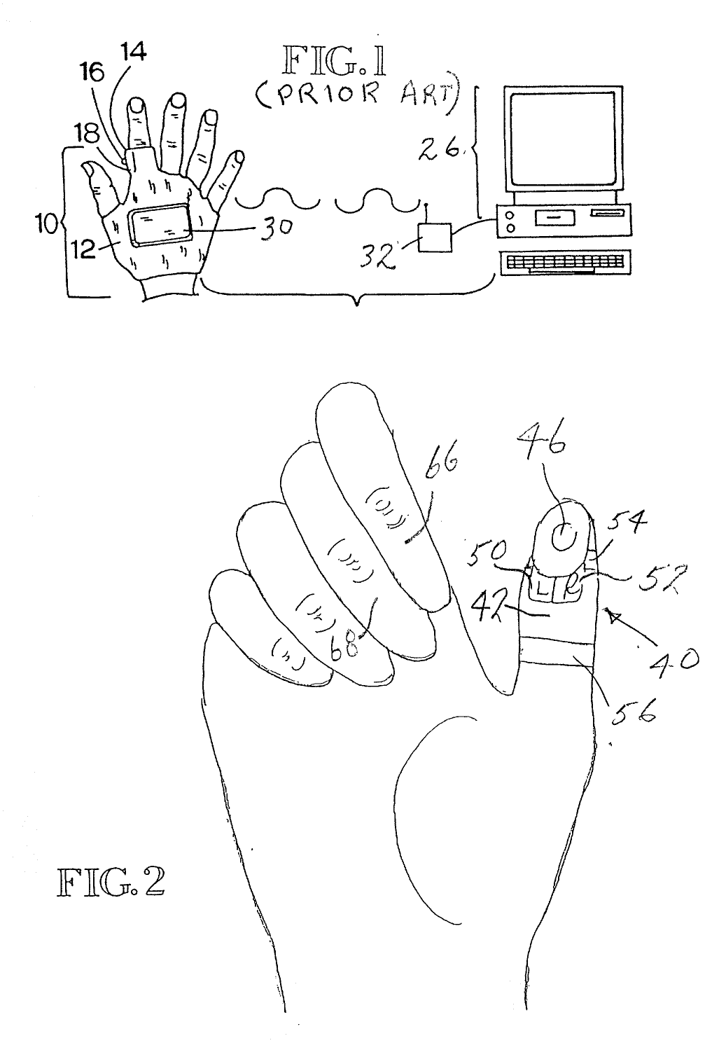

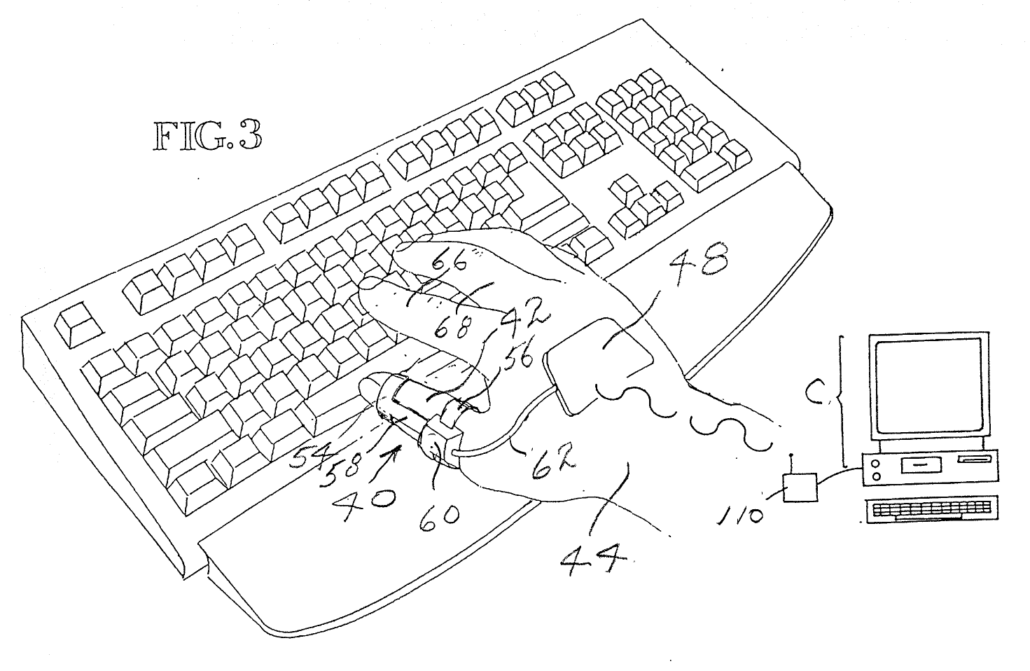

FIGS. 2-4 are like FIGS. 3, 1 and 2 of my provisional application Serial No. 60/295,757. These views show the basic elements of the invention and their relative positioning. Referring to FIG. 3, a pointing device 40 is shown mounted on the thumb 42 of a computer user's hand 44. The device 40 includes a rigid housing and a sensor 46 (FIG. 2) that may be a track ball or an optical sensor, or some other yet to be developed sensor for performing the same function. The sensor housing is positioned on the pad of the user's thumb and is adjustable in position on the thumb. It contains an optical integrated circuit, a lens, a light emitting diode (LED) and a pair of switches. A circuit board 48 is preferably mounted on the back of the computer user's hand 44. Referring to FIGS. 2 and 4, a pair of “click” buttons 50, 52 are preferably mounted on the user's thumb 42 closely adjacent the sensor 46. The thumb mounted housing is attached to a thumb band 54 that is located forwardly of the thumb knuckle. Band 54 snugly surrounds the portion of the thumb that projects outwardly from the thumb knuckle. The sensor 46 and the “click” buttons 50, 52 in the housing that is are connected to band 54. The necessary electrical conductors extend from the sensor 46 and the “click” buttons 50, 52 to the circuitry within housing 48.

Band 54 may be a full loop or a split loop of material into which a tip portion of the thumb 42 is inserted. Preferably, a second band 56 is provided on the thumb 42 inwardly of the thumb knuckle. Band 56 is preferably a two part band that is suitably secured together by a fastener, such as a Velcro® fastener. Structure 58 may be a strip of material with some stiffness but which can be bent and twisted to some extent.

Band 56 may include a housing 60 into which the member 58 extends. There are many ways of adjusting the device 40 for mounting it onto the computer user's thumb. For example, housing 60 may include a spring loaded retracting spool 61 on which the rear end portion of member 58 is wound, providing for continuous self adjustment between band 54 and band 58. Or, member 58 may be a member having end portions connected to the bands 54, 56 and a center portion that is built like an accordion so that the end portions can move together and away from each other. The electrical connectors associated with structure 58 extend between the two bands 54, 56. The conductors may be incorporated in the material of band 54 and strip 58. The conductors from the sensor 46 and the “click” buttons 50, 52 may be first incorporated within the member 58 and may emerge from the member 58 and enter a sheath 62 that extends from housing 60 to the housing 48. The conductors may be a bendable light gauge plastic coated wire, both within member 58 and within sheath 62.

Because a thumb tip tapers outwardly, the band 54 can be a split loop or a closed loop of a particular size. Adjustment is achieved by the distance of insertion of the thumb tip into the band 54. If the user's thumb tip is narrow, the thumb tip will move forwardly into the band 54 more than it will if the thumb tip is wider. When the band 54 is on the thumb tip, the band 56 is in position and adjusted to the user's thumb inwardly of the thumb knuckle. The structure 58 must be constructed to allow the resulting spacing of the bands 54, 56 along the thumb. If the spring loaded adjustment mechanism is used, the member 58 will move outwardly from housing 60 an amount necessary to provide for the necessary spacing of band 54 from band 56. If an accordion section is used, for example, it will either expand or contract, as necessary, to provide the necessary amount of adjustment.

FIG. 2 shows the “click” buttons 50, 52 positioned inwardly along the thumb from the sensor 46. They are also positioned side-by-side across the thumb 40. As shown by FIGS. 2 and 4, and to some extent by FIG. 3, the sensor 46 and the “click” buttons 50, 52 are in a confronting relationship with the user's fingers 66, 68 adjacent the thumb 40. This allows the index finger 66 or the middle finger 68 to be used to operate the sensor 46 and allows the fingers 66, 68 to be used to depress the “click” buttons 50, 52. This is hereinafter described in greater detail.

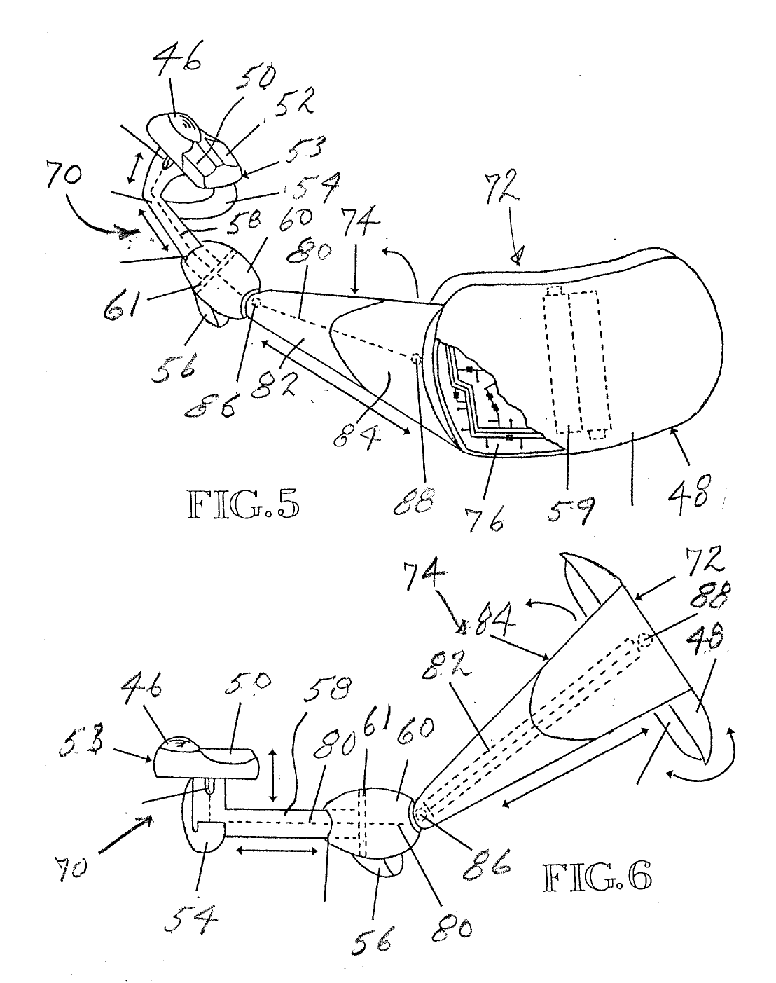

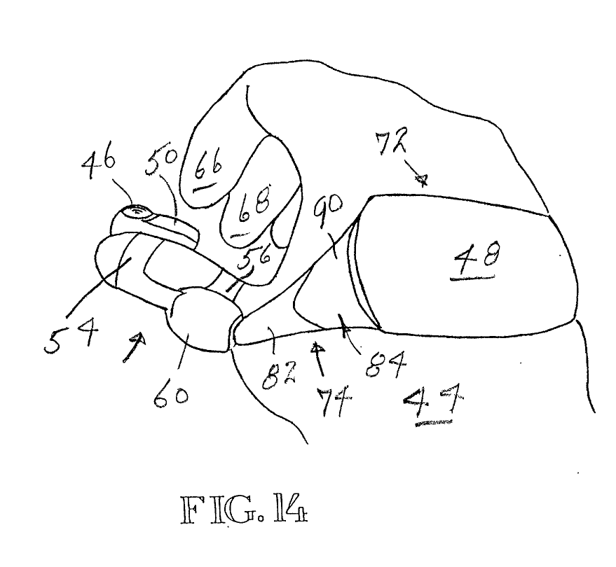

Referring to FIGS. 5-9, the preferred embodiment of the invention comprises a thumb-mounted structure 70 that includes the two thumb bands 54, 56, a sensor 46 and two “click” buttons 50, 52 integrated into a housing 53 that includes a printed circuit 55. It also comprises a control circuit section 72 that includes a housing 48, and a connecting section 74 that extends between and interconnects the section 70 with the section 72. In this embodiment, the housing 48 is positioned on the back of the user's hand 44 (FIG. 14). It contains a main printed circuit board 76 and houses batteries 78 that provide electrical energy to the circuit. The necessary conductors extend from the sensor 46 and the “click” buttons 50, 52 through sheathing or materials in the sections 70, 74 to the housing 48 in section 72. In FIGS. 5 and 6, the conductor path is designated 80. Housing 48 also houses a transmitter that sends a wireless signal to the computer.

Section 74 may comprise two end members 82, 84 that are connected together in an adjustable manner to make section 74 adjustable in length. Member 82 may be connected to housing 60 by a pivotal connection 86. Member 84 may be connected to housing 48 by a pivotal connection 88. Connections 86, 88 provide for pivotal movement between housings 60, 82 and housings 84, 48.

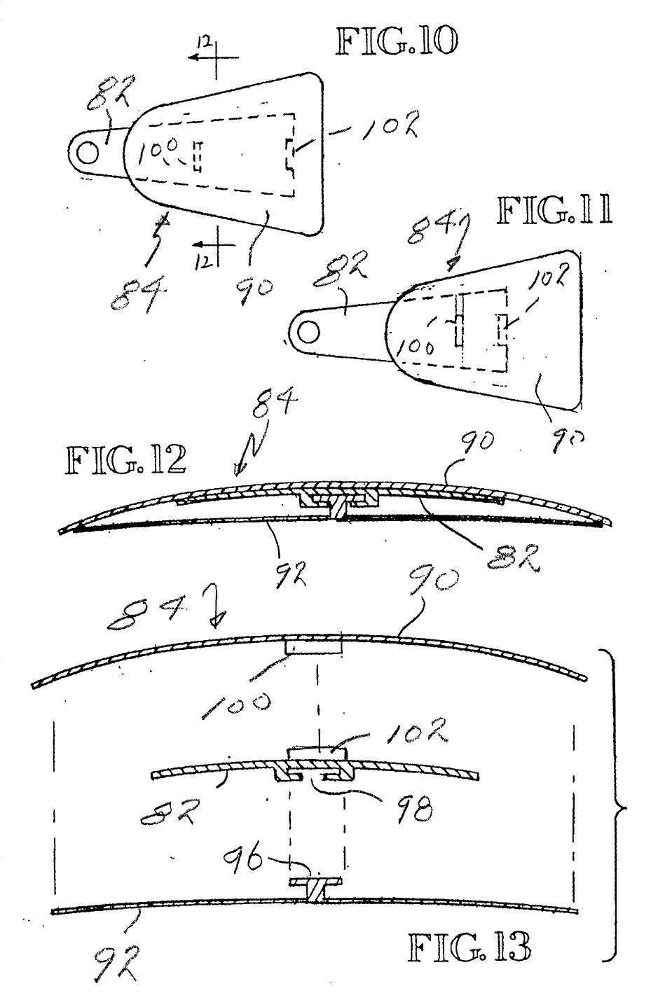

Referring to FIGS. 10-13, member 84 may include a top section 90 and a bottom section 92 that is connected to the top section 90. Section 82 includes a member 94 that is telescopically received within the members 90, 92. Member 92 includes a longitudinal slide member 96 and member 94 includes a longitudinal slide way 98 in which slide member 96 is received (FIG. 12). A stop 100 on member 90 is positioned to contact a stop 102 on member 94. The members 82, 84 are telescopically movable together and apart within limits provided by the stops 100, 102. The engagement of the slide 96 within the slide way 98 permits length adjustment of the member 74 while holding the members 82, 84 together and restrained against movement in other directions.

Use of the preferred embodiment will now be described. Firstly, the user's thumb is inserted into the band 54 and the housing 72 is positioned on the back of the user's hand. Members 82, 84 are extended or retracted as necessary to allow for the placement of the housing 72 on the back of the user's hand while the user's thumb is within band 54. Housing 53 is adjusted in position on the band 54. For this purpose, the housing 53 may include a lateral tunnel opening in which the band 54 is received. The band 54 is moved through this tunnel opening in the direction an amount necessary in order to properly place the housing 53 on the user's thumb. Band 56 is then secured to the user's thumb. In the process, the member 58 and reel 61 (or accordion section) will automatically adjust the distance between the bands 54, 56 along the user's thumb.

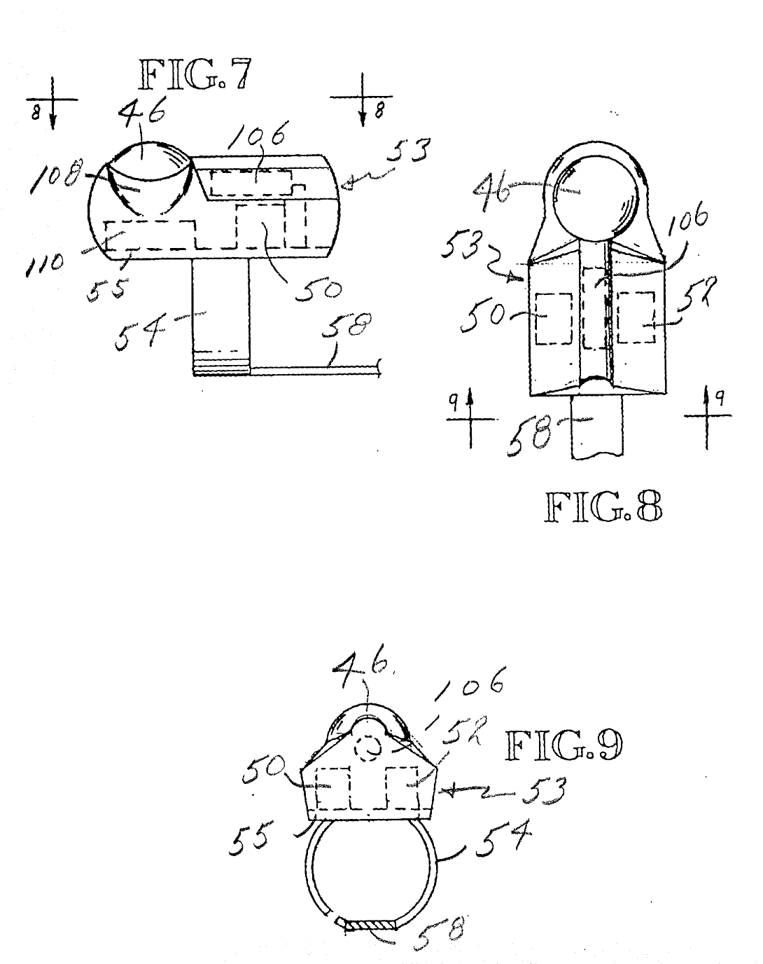

Referring to FIGS. 7, 8 and 9, a LED 106 is preferably provided to illuminate the user's index finger as it passes over a lens 108, which that is a part an optical integrated circuit 110 uses for functionality and contained within the housing 30. The optical integrated circuit 110 senses the movement and in response causes movement of the cursor or pointer on the video display. The “click” buttons 50, 52 are activated by movement of the user's index and middle fingers 66, 68. Switch buttons 50, 52 control specific software and pointing device functions substantially the same as is done in the “MouseMan® pointer device.

Commercially available batteries 59 are used to provide the necessary electrical energy. These batteries 59 are housed within the housing 48. The batteries 59 may be rechargeable batteries, and if so, the pointing device is a connected to a battery charger (not shown) when it is not in use. A radio transmitter within the housing 48 transmits signals to a receiver 110 that is adapted to supply control signals to the computer C (FIG. 3).

In another embodiment, the member 58 extends through a slot in the housing 60 and then extends continuously onto the housing 48. In this embodiment, there may be a frictional grip between the housing 60 and the member 48. Or the housing 60 may include a spring biased detent that engages the member 58 and releasably secures the two of them together. The detent may be released when it is desired to move the member 58 relatively through housing 60 for the purpose of adjusting the position of band 56 relative to band 54. The section of member 58 that extends between housing 60 and housing 48 may include an accordion section that will provide for its adjustment in length where it extends between housing 60 and housing 48.

As can be seen, when the sensor 46 and the “click” buttons 50, 52 are properly positioned on the user's thumb, the sensor 46 is positioned for operation by a relative movement of one of the user's fingers across the optical sight of the sensor. The “click” buttons are positioned for quick and easy access and operation by use of the user's index and middle finger 66, 68. As a result, the pointing device of this invention does not possess the problems inherent to surface based pointing devices.

The thumb mounted housing may be made from plastic. As has been described, it is movable in position around the girth of the thumb so that it can best be positioned for operation by the index and/or middle fingers of the user. The band 54 may be constructed from plastic coated thin metal that is flexible.

The illustrated embodiments are only examples of the present invention and, therefore, are non-limitive. It is to be understood that many changes in the particular structure, materials and features of the invention may be made without departing from the spirit and scope of the invention. For example, the “click” buttons can be positioned other than side-by-side. In some embodiments they may be spaced along the thumb, or otherwise positioned. Therefore, it is my intention that my patent rights not be limited by the particular embodiments illustrated and described herein, but rather are to be determined by the following claims, interpreted according to accepted doctrines of patent claim interpretation, including use of the doctrine of equivalents and reversal of parts.

What is claimed is:

1. A hand operated input device for a computer that includes a screen and a cursor moveable on the screen, said input device, comprising:
a band that is mountable on a computer user's thumb;
a sensor on the band that is directed towards the user's fingers adjacent the thumb;
a cursor control circuit that includes said sensor; and
wherein finger movement across the sensor controls x-y positioning of the cursor on the computer screen.

2. The input device of claim 1, further comprising at least one “click” button on the band adjacent the sensor.

3. The input device of claim 1, further comprising a pair of “click” buttons on the band adjacent the sensor.

4. The input device of claim 3, wherein the “click” buttons are positioned side-by-side across the thumb and the sensor is positioned outwardly on the thumb from the “click” buttons.

5. The input device of claim 1, wherein the band is positionable on the computer user's thumb outwardly of the thumb knuckle.

6. The input device of claim 1, further comprising a housing positionable on the back of the computer user's hand, control circuitry within said housing, and at least one conductor extending from the sensor along the computer user's thumb and hand to the circuitry within said housing.

7. The input device of claim 6, further comprising a second band that is mountable on the computer user's thumb inwardly of the thumb knuckle, said conductor extending from the sensor to the second band and from the second band to the circuitry within said housing.

8. the input device of claim 6, further comprising at least one “click” button on the band adjacent the sensor, and at least one conductor extending from the “click” button along the computer user's thumb and hand to the circuitry within said housing.

9. The input device of claim 6, further comprising a pair of “click” buttons on the band adjacent the sensor, and at least one conductor extending from each “click” button along the computer user's thumb and hand to the circuitry within said housing.

10. The input device of claim 1, comprising a sheath for said at least one conductor in which said at least one conductor is housed, said sheath being thin and flat and extending from the band along the computer user's thumb and hand to said housing.

11. The input device of claim 1, wherein the sensor is an optical sensor.

12. The input device of claim 11, further comprising at least one “click” button on the band adjacent the optical sensor.

13. The input device of claim 11, further comprising a pair of “click” buttons on the band adjacent the optical sensor.

14. The input device of claim 13, wherein the “click” buttons are positioned side-by-side across the thumb and the sensor is positioned outwardly on the thumb from the “click” buttons.

15. The input device of claim 11, wherein the band is positionable on the computer user's thumb outwardly of the thumb knuckle.

16. The input device of claim 15, comprising a second band that is mountable on the computer user's thumb inwardly of the thumb knuckle.
